(19) United States
(12) Patent Application Publication
(10) Pub. No.: US 2009/0072047 A1
(43) Pub. Date: Mar. 19, 2009

(54) AIRCRAFT DEFENSE SYSTEM AND METHOD

(76) Inventor: Leonard M. GREENE, Mamaroneck, NY (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/427,499

(22) Filed: Jun. 29, 2006

Related U.S. Application Data
(63) Continuation-in-part of application No. 11/199,267, filed on Aug. 9, 2005.

(51) Int. Cl. F02C 7/141; F02K 1/78; B64C 27/04

(52) U.S. Cl. 239/127.3; 60/772; 60/39.5; 244/17.13

(57) ABSTRACT

A method and system for aiding an aircraft pilot to avoid being struck by a heat seeking missile includes the steps of providing a mass of water and a missile detector for detecting an incoming heat seeking missile. The water is contained in a tank that extends around an exhaust plume and is adapted to eject water onto and into the housing. The cooling water is ejected out of the tank and into the exhaust plume to thereby cool the exhaust plume and disrupt the guidance system of an incoming missile.

This application is a Continuation-In-Part of U.S. application Ser. No. 11/199,267 filed on Aug. 9, 2005.

### FIELD OF THE INVENTION

This invention relates to a missile defense system for aircraft and methods for evading heat seeking missiles and more particularly to methods and systems for reducing exhaust and engine temperature.

### BACKGROUND FOR THE INVENTION

Representatives of the U.S. government, the airline industry and aircraft pilots recognize that terrorists may attempt to fire a surface to air missile such as a man-portable air defense system (MANPADS) at a commercial or civil aircraft. As reported in an International Federation of Airline Pilot's Association, and Security Bulletin of 31 Mar. 2003, the FAA issued a notice that states in part that there is no credible evidence that terrorists have smuggled MANPADS into the United States. Nevertheless, the potential for such a threat does exist. The threat is exacerbated by a large number of unaccounted for MANPADS many of which may be in the hands of terrorist organizations.

In view of the threat, the Department of Homeland Security on Oct. 3, 2003 issued a solicitation RA-02 for a Counter-Man-Portable Air Defense System. As reported therein, the Department of Homeland Security “is initiating a program for the development of an anti missile device for commercial aircraft.” The Department of Homeland Security also identified an on-board jamming (directed infrared counter measure (DIRCM) as the most promising existing technology which is capable of good performance against the current and emerging threats while potentially satisfying operational constraints.

Then on Jan. 7, 2004, the Washington Post reported that “the Department of Homeland Security which has identified shoulder fired missiles as threats to commercial aircraft, chose three companies to develop anti missile technology.” As reported, the government proposal calls for adapting military technology to commercial planes—a concept of which many are skeptical.

There are serious problems associated with adopting military technology to commercial aircraft. For example, the cost for equipping each aircraft has been estimated to be about 5 million dollars. Further, the cost for equipping 6,800 plus commercial jets with such systems has been estimated at between 7 to 10 billion dollars. Even at that cost, corporate jet and other non-commercial aircraft would be unprotected. More recent estimates reduce these cost for equipping aircraft to protect them from heat seeking missiles at one to two million dollars per aircraft.

An additional problem with military technology relates to the deployment of flares to divert a heat seeking missile. The deployment of flares over heavily populated areas could cause fires and/or death on the ground. Further, there is little or no need to protect the aircraft at altitudes beyond the range of present day or envisioned man-portable or shoulder launched surface to air missiles.

Helicopters are flown at relatively low altitudes and relatively slow speeds and are particularly vulnerable to an attack from a shoulder fired ground to air missile. Therefore, there is a need for an improved helicopter defense system and method in accordance with the present invention. In addition, such systems and methods should avoid problems relating to the deployment of pyrotechnic flares, are relatively inexpensive, durable, reliable and readily installed on many if not most helicopters.

It is now believed that a pilot of an airborne helicopter may be able to avoid being struck by a heat seeking missile by a method and/or system in accordance with the present invention. The method involves the steps of providing a missile detection system and a mass of coolant, and upon detection of a heat seeking missile such as detecting “lock-on” the method includes the immediate or almost immediate injection of coolant into an exhaust plume and/or onto an exhaust duct to cool the exhaust and thereby disrupt a missile's guidance system. After that, the pilot continues his flight pattern or takes other evasive action.

### BRIEF SUMMARY OF THE INVENTION

In essence, the present invention contemplates a method and system for aiding an airborne pilot of a fixed wing or rotary wing aircraft to avoid being struck by a heat seeking or Infra Red (IR) missile. The method includes the step of providing a missile detection system that detects a “lock-on” by or launch of a heat seeking missile. Such systems are well known and used in military aircraft and are considered to be conventional.

The method also includes the step of providing a mass of coolant such as water in close proximity to the engine as for example about the engine. Then when the missile detection system detects a “lock-on” or incoming missile, a mass of coolant is immediately or almost immediately ejected into the exhaust plume or onto the exhaust duct creating a cloud of steam to thereby rapidly cool or passivate the exhaust and/or the exhaust area of the engine to thereby confuse the guidance system of the missile. After this step, a pilot continues on course or elects to change course.

A second embodiment of the invention contemplates a system which includes a missile detector and water dispenser. The missile detector is any of the well known military types for detecting incoming missiles while the water storage and ejection means contains a mass of water and means such as compressed gas for injecting a mass of water into the exhaust plume and/or onto the exhaust duct to cool the exhaust and thereby disrupt a missile's guidance system. It should be recognized that in this case a mass of water is preferably injected as opposed to a spray so that the water is almost immediately converted to steam by the high temperature of the exhaust which results in rapid cooling of the exhaust plume and an area around the engine.

The invention will now be described in connection with the accompanying drawings.

### BRIEF DESCRIPTION OF THE DRAWINGS

FIG. 1 is a schematic illustration of a missile defense system in accordance with the present invention;

FIG. 2 is a block diagram illustrating a second embodiment of the invention; and

FIG. 3 is a block diagram illustrating a further embodiment of the invention.

### DESCRIPTION OF THE PREFERRED EMBODIMENT OF THE INVENTION

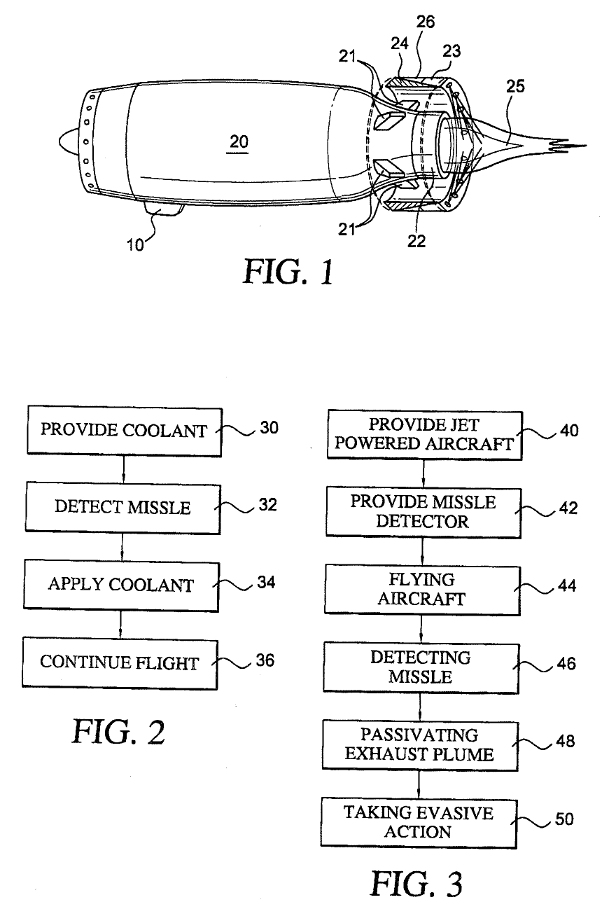

A missile defense system in accordance with a first embodiment of the invention is illustrated in FIG. 1. As shown, the system includes means such as a detector 10 for detecting a heat seeking missile that is aimed at the aircraft. The detector 10 is of a conventional design as used on military aircraft and triggers an immediate or almost immediate response upon detection of the missile.

A key element in the present system resides in means for ejecting a mass of coolant such as water into the exhaust plume or perhaps onto an exhaust housing 22 or tailpipe of an engine 20. For example, the engine 20 includes a second or outer housing 24 that extends around the exhaust housing 22 and may extend beyond the back of the exhaust housing 22 so that a mass of water contained in a tank 23 can be ejected into the exhaust plume to rapidly cool or essentially quench the hot exhaust gases.

In a preferred embodiment of the invention, water is injected into the exhaust plume 25 i.e. to the rear of the exhaust duct 22 or tailpipe in the direction of the plume 25. Tests conducted on a helicopter jet engine showed that 30 gallons of water reduced the heat of the plume or passivated the plume. The passivation of the plume was sufficient to remove the engine IR signature from a missiles tracking system.

As illustrated schematically a source of compressed gas 26 or other means is used to force the mass of water out of the tank 23 and into the exhaust housing 22. As shown, the outer housing 24 extends around the exhaust housing 22 and is mounted on the helicopter engine by a plurality of supports 21. It is also contemplated that a plurality of heat resistant nozzles may be used to inject water into the plume 25 and that the water tank can be moved to some other location. The electronics for immediate actuation of the water quench are similar to the electronics for activating other missile defense systems and are considered to be conventional or well within the ability of a person of ordinary skill in the art.

The invention also contemplates a method for aiding a helicopter to avoid being struck by a heat seeking missile as illustrated in FIG. 2. As illustrated, the method includes the step 30 of providing a mass of coolant for rapidly cooling an engine exhaust plume and a detector for detecting a heat seeking missile that is aimed at the helicopter. The detector detects an incoming missile in step 32 as for example by detecting a “lock-on” in a conventional manner. Immediately upon detection of an incoming missile, a mass of coolant such as water is ejected into the exhaust plume in step 34. The water is converted to steam and rapidly drops the temperature of the exhaust plume to disrupt the missile guidance system.

The mass of water needed to cool the exhaust may vary from aircraft to aircraft but it is presently believed that a little as six to ten gallons may be sufficient. Testing indicated that 30 gallons of water would be sufficient on a test engine. Actual amounts can be readily determined by physical testing and/or computer analysis.

Following the water injection, the aircraft continues on its course in step 36 or may take other evasive or defensive action.

A further embodiment of the invention is illustrated in FIG. 3 wherein a jet powered aircraft such as a helicopter is provided in step 40. The helicopter is equipped with a conventional missile detector in step 42 and the aircraft flown in a conventional manner in step 44. During flight a missile launch or “lock-on” by an IR or heat seeking missile is detected in step 46 and in step 48 the exhaust plume produced by the jet helicopter's jet engine is immediately passivated. For example, a mass of water may be injected into the exhaust plume to cool the plume to thereby disrupt or in effect obliterate the target as seen by the missile tracking system. It is also contemplated that water may also be directed onto the engine's tailpipe which is an intense source of IR radiation.

It has been recognized that from a practical view it is not possible to eliminate the IR signature of an aircraft. However, with the present invention, it is possible to sufficiently remove or temporarily passivate the IR signature in order to avoid a missile strike. Finally, the pilot can take evasive action as for example continuing with a flight plan in step 50 to avoid the missile.

While the invention has been described in connection with its preferred embodiments, it should be recognized that changes and modifications may be made therein without departing from the scope of the appended claims.

1. (canceled)

2. (canceled)

3. (canceled)

4. An aircraft missile defense system comprising:
a helicopter, a jet engine and means for detecting a heat seeking missile;
said jet engine having a tailpipe including an exhaust duct and producing an exhaust plume;
and in which said jet engine includes an exhaust housing around said exhaust duct and an outer housing extending around said exhaust housing and beyond said exhaust duct;
a plurality of mounting members disposed between said outer housing and said exhaust housing for mounting said outer housing on said exhaust housing around said exhaust housing and in spaced relationship therewith;
and in which said outer housing includes means for storing a mass of water;
and means including a plurality of heat resistant nozzles for ejecting the water onto said tailpipe and into the plume for cooling the engine's exhaust plume and tailpipe.

5. An aircraft missile defense system according to claim 4, in which said means for ejecting a mass of water includes a compressed gas.

6. (canceled)

7. (canceled)

8. A method for aiding a helicopter pilot to avoid being struck by a heat seeking missile comprising the steps of:
providing a helicopter and a jet engine having a tailpipe for powering the helicopter and producing an exhaust plume at an end of the tailpipe and wherein the engine includes an exhaust housing extending around the tailpipe and beyond the end of the tailpipe;
providing an outer housing extending around the exhaust housing and spaced therefrom by a plurality of mounting members;
providing a plurality of heat resistant nozzles and a mass of coolant in the outer housing and a detector for detecting an incoming heat seeking missile;
detecting an incoming heat seeking missile;
disrupting a missile's tracking system by ejecting the mass of coolant through the heat resistant nozzles onto the tailpipe and into the exhaust plume to cool the helicopter's engine exhaust plume and tailpipe; and
continuing a flight to thereby avoid being struck by the incoming missile.

9. A method for aiding a helicopter pilot to avoid being struck by a heat seeking missile according to claim 8 in which water from the outer housing is ejected into the exhaust plume and onto the tailpipe to cool the exhaust plume and tailpipe.
